(19) United States
(12) Patent Application Publication
(10) Pub. No.: US 2010/0258594 A1
(43) Pub. Date: Oct. 14, 2010

(54) DISPENSING HEAD FOR DISPENSERS OF FLUID PRODUCTS

(75) Inventors: Lamberto Carta, Pescara (IT); Marco Zavarella, Sulmona (AQ) (IT)

Correspondence Address: YOUNG & THOMPSON, 209 Madison Street, Suite 500, Alexandria, VA, 22314, US

(73) Assignee: EMSAR S.P.A., San Giovanni Teatino (CH) (IT)

(21) Appl. No.: 12/742,662

(22) PCT Filed: Sep. 24, 2008
(86) PCT No.: PCT/IT2008/000612

§ 371 Date: May 13, 2010

(30) Foreign Application Priority Data
Nov. 16, 2007 (IT) RM2007A000598

(51) Int. Cl. B67D 3/00

(52) U.S. Cl. 222/533; 222/536

(57) ABSTRACT

A dispensing head for dispensers of fluid products includes: a connecting body (3) operatively engaged to a dispensing pump of a respective dispenser (2) of the fluid product; and a nozzle (4) for dispensing the liquid product, associated to the connecting body (3) and rotatably associated on a surface (7) of the connecting body (3) to rotate between a position of use in which it projects from the surface (7) of the connecting body (3), and a position of non use in which it is retracted inside the overall size of the surface (7).

### TECHNICAL FIELD

The present invention relates to a dispensing head for dispensers of fluid products. In particular, the present invention relates to a dispensing head advantageously applied to manually operated reciprocating dispensers, coupled to bottles for the containment of fluid products.

### BACKGROUND ART

As is well known, dispensing heads comprise a cylindrical body, presenting a lower portion appropriately coupled to the activating members of a respective dispenser. The dispensing head is generally switchable between a condition of use, in which it is free to slide vertically towards/away from the dispenser, and a condition of non use in which it is locked on appropriate reference abutments. The use/non use mode of the dispensing head is determined by manually rotating the cylindrical body relative to the dispenser. On the top of the cylindrical body develops a support to exercise the delivery action, generally constituted by a flat surface which the user can operate with a finger to push the entire head, in the respective condition of use, towards the dispenser. In this way, the vertical actuation of the cylindrical body determines the operation of the dispenser which conveys the liquid product into a flow channel obtained in the cylindrical body itself.

On the top of the cylindrical body also develops an internally hollow spout from which the product passing through the flow channel is distributed to the exterior. The spout for the distribution of the product extends radially relative to the longitudinal development of the cylindrical body. Consequently, the presence of the spout determines immediately and clearly for the final user the point whence the liquid is dispensed. However, the structure of the entire dispensing head determines an asymmetrical extension which, during the steps of assembly and transport, generates process challenges and needs particular care.

The spout of the head can accidentally become ensnared during transport and cause the fall of the bottles or the accidental removal of the dispenser. Moreover, the spout markedly complicates the steps of packaging the finished product both with cardboard but above all with heat-shrinking films which, if they are wound on the dispensing spout introduce a flexion stress of the entire system with possible malfunctions and disassembly.

### DISCLOSURE OF INTENTION

In this context, the technical task of the present invention is to propose a head for dispensing fluid products that is free of the aforesaid drawbacks. In particular, an object of the present invention is to propose a dispensing head for dispensers of fluid products, provided with a symmetric structure, lacking element projecting from the transverse dimension of the dispensing head.

More in particular, an object of the present invention is to propose a dispensing head that is produced assembled and shipped with the spout retracted and subsequently extracted by the final user upon opening the system before dispensing the product the first time.

In accordance with the present invention, the technical task and the described objects are achieved by a dispensing head for dispensers of fluid products comprising the technical characteristics set out in one or more of the appended claims.

### DESCRIPTION OF THE DRAWINGS

Further characteristics and advantages of the present invention shall become more readily apparent from the indicative, and therefore non limiting, description of a preferred but not exclusive embodiment of a dispensing head for dispensers of fluid products, as illustrated in the accompanying drawings in which:

FIG. 1a illustrates a perspective view of a dispensing head in accordance with a first embodiment of the invention in a respective condition of non operation;

FIG. 1b shows a perspective view of the dispensing head of FIG. 1a, in a respective condition of operation;

FIG. 2 shows a perspective exploded view of the dispensing head and of a respective dispenser;

FIGS. 3 and 4 illustrate perspective views, respectively from the bottom and from the top, of a construction detail of the dispensing head;

FIG. 5 shows a top plan, partially sectioned view of an additional construction detail of the dispensing head.

### DESCRIPTION OF THE ILLUSTRATIVE EMBODIMENT

With reference to the accompanying figures, a dispensing head according to the present invention, for dispensers 2 of fluid products, is indicated in its entirety with the number 1.

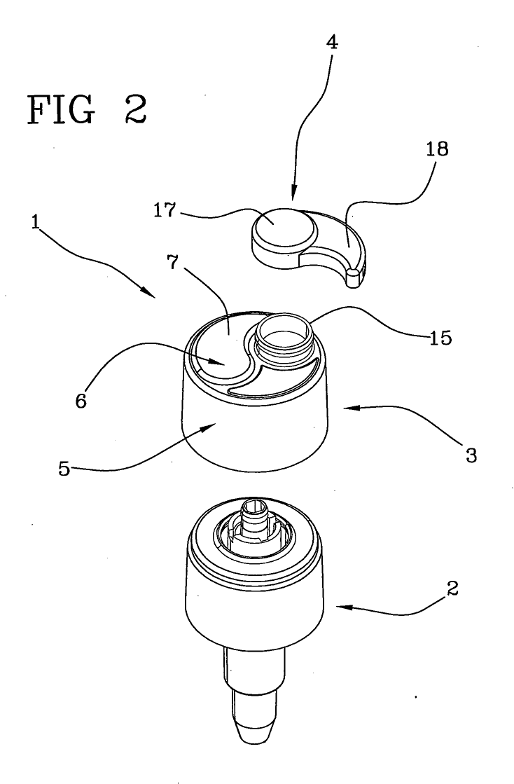

In particular, as shown in the exploded view of FIG. 2, the head 1 is constituted by a connecting body 3, and by a dispensing nozzle 4.

The connecting body 3 presents substantially cylindrical shape with circular cross section and defining a lateral wall 5 and a circular upper wall 6.

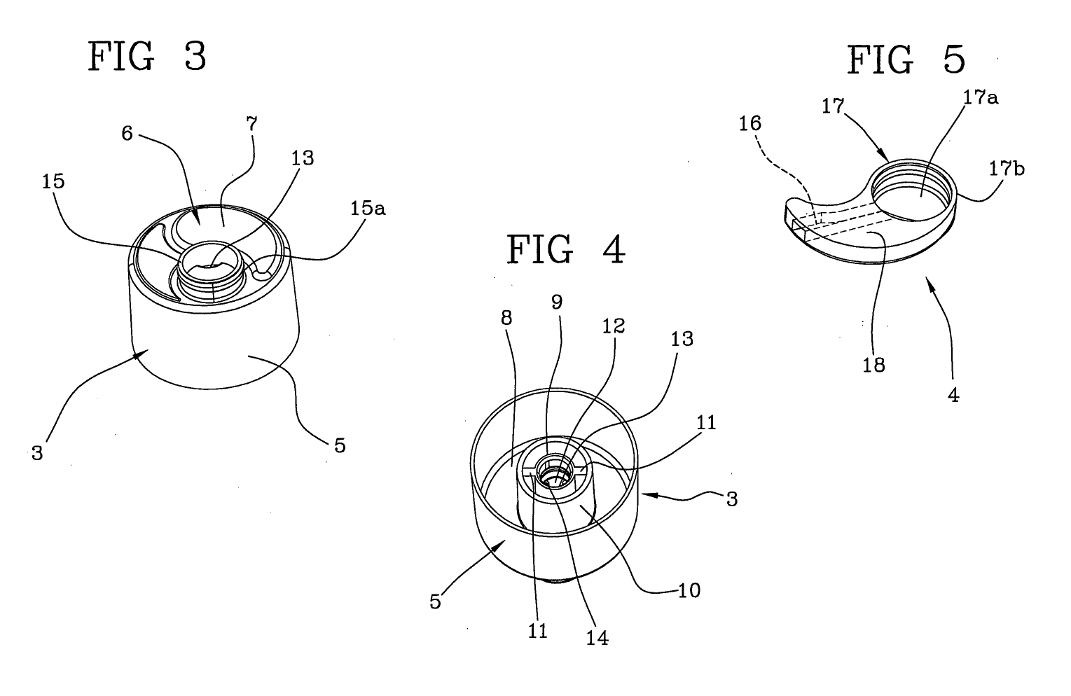

As is better shown in FIG. 3 and in FIG. 4, the upper wall 6 presents an outer upper surface 7 and a lower surface 8 opposite to the upper surface 7.

Additionally, note that the body 3 presents an inner hollow conduit 9 and an outer hollow conduit 10 positioned concentrically, having the same height and extending from the aforesaid lower surface 8. Between the outer conduit 10 and the inner conduit 9 are positioned two inner projections 11, diametrically opposite and meant to engage with corresponding slots present in the pump of the dispenser 2, according to known methodologies, not described and illustrated in detail.

Advantageously, the connecting body 3 is switchable between an operating condition in which the inner projections 11 are slidable in the cavities of the pump, to dispense the liquid product along a channel 12 extending within the inner conduit 9 and ending in a respective opening 13 obtained on the upper wall 5, and a non operating condition in which the inner projections 11 abut on the plane of abutment of the dispensing pump of the dispenser 2, in order not to dispense the liquid product.

The inner conduit 12 presents arresting rabbets 14 to prevent an excessively low fitting during assembly. In the proposed embodiment, four arresting rabbets 14 arranged circumferentially are provided.

The body 3 also presents a connecting conduit 15, emerging from the upper surface 7 of the upper wall 6 and positioned at the opening 13 for the passage of the liquid product obtained on the upper wall 6 and in fluid communication with the aforesaid inner conduit 12.

Note that the connecting conduit 15 is positioned in an eccentric area relative to the axis of longitudinal development of the connecting body 3. It should also be noted that the opening 13 has a smaller passage section than the inner amplitude of the connecting conduit 15 and of the channel 12.

In particular, the conduit 15 has substantially tubular shape and comprises an outer surface 15a of engagement with the dispensing nozzle 4, preferably provided with a system for the snapping arrest of the nozzle 4, of a known kind, such as to transmit to the final user the tactile perception of the “open” and “shut” state of the nozzle 4 by means of a noticeable change in the actuation load.

The dispensing nozzle 4 comprises a cylindrical body 17 provided with an upper wall 17a and an annular lateral wall 17b defining, in collaboration with the upper wall 17a, a compartment for the passage of the liquid product. The cylindrical body 17 is fitted on the aforesaid conduit 15 in such a way as to associate the outer surface 15a with the lateral wall 17b of the cylindrical body 17. In this situation, the cylindrical body 17 is rotatable relative to the conduit 15 and relative to the entire connecting body 3. The nozzle 4 further presents a projecting spout 18, extending laterally from the cylindrical body 17 and internally presenting a conduit 16 for the outflow of the liquid product.

As is better shown in FIG. 5, the output conduit 16 is in communication with the interior of the cylindrical body and consequently with the opening 13 obtained on the connecting body 3.

It should also be noted that the projecting spout 18 presents, by way of example, substantially wedge-like shape, with the vertex located at the outflow conduit 16, and with respective arched lateral walls. However, the shape of the spout 18, as well as the structure of the entire nozzle 4 can be any, depending on the various aesthetic and constructive requirements.

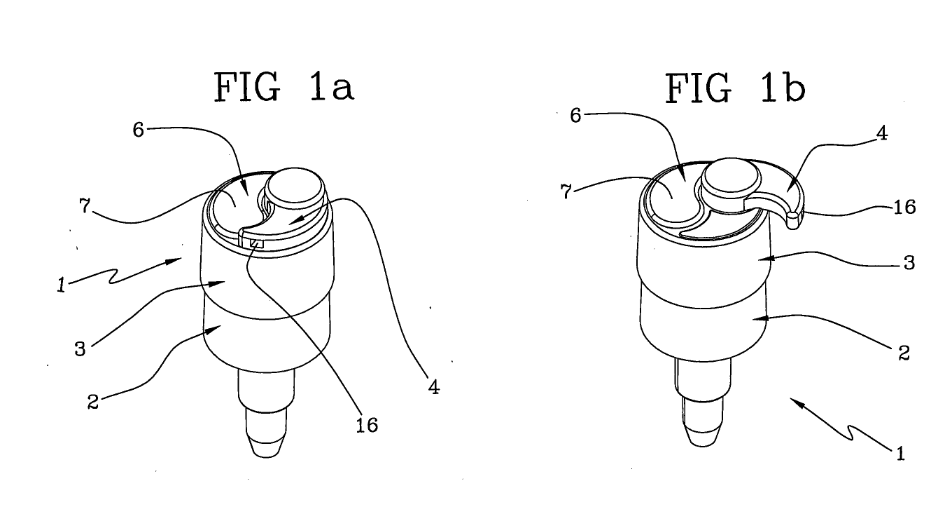

As shown in FIGS. 1a and 1b, the nozzle 4 is manually rotatable between a position of use in which it projects from the aforesaid surface 7 of the upper wall 6, and a position of non use in which it is retracted within the overall size of the surface 7.

In this way, the action of opening/closing of the nozzle 4 on the connecting body 3 occurs at a distinct time from the operating condition of the connecting body (condition of dispensing or non dispensing of the fluid product).

It should be noted, moreover, that, when the nozzle 4 is retracted on the surface 7 of the upper wall 6, the nozzle follows with a lateral wall the peripheral development of the connecting body 3. In this way, no part of the nozzle 4 projects transversely from the entire dispensing head 1.

The invention achieves the proposed objects and provides important advantages. Note that the dispensing nozzle 4 is extracted only at the user's discretion to dispense the liquid product. In this way, when packaging and stocking the finished product, the nozzle 4 can be kept within the transverse size of the lid 7. Advantageously, the packaging and transport operations are simplified, preventing the nozzle 4 from damaging the heat-shrinking films and preventing any accidental engagement between the nozzles 4 of the dispensing heads 1 stored next to each other.

Moreover, stresses on the nozzle are avoided, which would mostly be due to the action of the heat-shrinking material that wraps the finished product, preserving the dispensing head 1 from malfunctions and disassembly.

1. A dispensing head for dispensers of fluid products comprising:
a connecting body (3) operatively engaged to a dispensing pump of a respective dispenser (2) of the fluid product; and
a nozzle (4) for dispensing the liquid product, associated to said connecting body (3);
characterised in that said dispensing nozzle (4) is rotatably associated on a surface (7) of the connecting body (3) to rotate between a position of use in which it projects from said surface (7) of the connecting body (3), and a position of non use in which it is retracted inside the overall size of the surface (7).

2. Head as claimed in claim 1, characterised in that said connecting body (3) has cylindrical shape, said surface (7) being positioned in an upper wall (6) of the body (3) presenting planar development perpendicular to the axis of longitudinal development of the body (3) itself.

3. Head as claimed in claim 2, characterised in that it further comprises a connecting conduit (15), emerging from said surface (7) of the connecting body (3) and positioned at an opening (13) for the passage of the liquid product obtained on said surface (7); said nozzle (4) being associated to the connecting conduit (15).

4. Head as claimed claim 3, characterised in that said connecting conduit (15) has substantially tubular shape and comprises an outer surface (15a) for engaging with said dispensing nozzle (4).

5. Head as claimed in claim 3,
characterised in that said connecting conduit (15) is positioned in an eccentric area relative to the axis of longitudinal development of said connecting body (3).

6. Head as claimed in claim 3, characterised in that said opening (13) has a smaller passage section than the inner amplitude of said connecting conduit.

7. Head as claimed in claim 3, characterised in that said dispensing nozzle (4) comprises a cylindrical body (17) fitted on the conduit (15);
said outer surface (15a) being associated internally to the cylindrical body (17) to allow the rotation of the nozzle (4) relative to the connecting conduit (15).

8. Head as claimed in claim 7, characterised in that said nozzle (4) further comprises a projecting spout (18), extending laterally from the cylindrical body (17) and presenting internally a conduit (16) for the outflow of the liquid product; said outflow conduit (16) being in fluid communication with the opening (13) obtained on the connecting body (3).

9. Head as claimed in claim 8, characterised in that in the position of use of the nozzle (4), the spout (18) projects least partially outside the surface (7), and in the position of non use of the nozzle (4), the spout (18) is internally abutted on the surface (7).

10. Head as claimed in claim 4, characterised in that said connecting conduit (15) is positioned in an eccentric area relative to the axis of longitudinal development of said connecting body (3).

11. Head as claimed in claim 4, characterised in that said opening (13) has a smaller passage section than the inner amplitude of said connecting conduit.

12. Head as claimed in claim 5, characterised in that said opening (13) has a smaller passage section than the inner amplitude of said connecting conduit.

13. Head as claimed in claim 4, characterised in that said dispensing nozzle (4) comprises a cylindrical body (17) fitted on the conduit (15); said outer surface (15a) being associated internally to the cylindrical body (17) to allow the rotation of the nozzle (4) relative to the connecting conduit (15).

14. Head as claimed in claim 5, characterised in that said dispensing nozzle (4) comprises a cylindrical body (17) fitted on the conduit (15); said outer surface (15a) being associated internally to the cylindrical body (17) to allow the rotation of the nozzle (4) relative to the connecting conduit (15).

15. Head as claimed in claim 6, characterised in that said dispensing nozzle (4) comprises a cylindrical body (17) fitted on the conduit (15); said outer surface (15a) being associated internally to the cylindrical body (17) to allow the rotation of the nozzle (4) relative to the connecting conduit (15).
